(19) United States
(12) Patent Application Publication
(10) Pub. No.: US 2024/0018988 A1
(43) Pub. Date: Jan. 18, 2024

(54) ANCHORABLE CLIP / WIRING HARNESS

(71) Applicant: Marc Lecours, Windsor (CA)

(72) Inventor: Marc Lecours, Windsor (CA)

(21) Appl. No.: 16/656,155

(22) Filed: Oct. 17, 2019

(51) Int. Cl. F16B 21/08; F16B 13/02

(52) U.S. Cl. CPC F16B 21/084; F16B 13/02

(57) ABSTRACT

An anchorable clip comprises a first main body portion and a second main body portion together reconfigurable between an initial configuration and an in-use configuration. The first main body portion and the second main body portion together define, in the in-use configuration: an insertable shank; a base; and a clip member. Displaceable projections project outwardly from the first main body portion and the second main body portion for engaging the article adjacent the receiving aperture to thereby preclude the anchorable clip from being removed from the receiving aperture. The first main body portion comprises a first shank portion of the insertable shank, a first base portion of the base, and a first clip portion of the clip member, and the second main body portion comprises a second shank portion of the insertable shank, a second base portion of the base, and a second clip portion of the clip member.

### FIELD OF THE INVENTION

The present invention relates to anchorable clips, and more particularly to reconfigurable anchorable clips.

### BACKGROUND OF THE INVENTION

It is well known to use insertable plastic clips to attach netting, wires, and the like, to articles, such as a frame, such as a hockey net frame or to an automobile frame or a wiring panel, respectively, among many other types of articles. It is desirable to have the clip be robust, both from the standpoint of insertion into a receiving aperture in an article, if appropriate, and also from the standpoint of precluding removal of the clip from the article. Also, it is desirable to have the clip be robust from the standpoint of precluding removal of the wires, netting or the like, as the case may be, from the clip.

Various embodiments of such prior art clip can be found in related U.S. Pat. No. 5,758,987, issued Jun. 2, 1998, to Frame et al., and entitled Snap-In Fastener For Flush Mounted Panels, and U.S. Pat. No. 6,042,296, issued Mar. 28, 2000, to Wittig et al., and entitled Snap-In Fastener For Panels. These two patents share three common inventors, and each disclose a fastener that connects panel members in a flush position. The fastener includes a pair of connecting members which are snap-fit within apertures provided within each of the panel members for securing the panel members together. The fastener also disconnects the panel members when secured together. For this purpose, at least one of the connecting members is removable from the panel member aperture to disconnect the panel members. The fastener allows the panels to be assembled together and disassembled quickly and with little or no tooling.

It has been found that such prior art cannot readily be used for attaching netting or wiring to an article.

The closest known prior art devices and their relevance will now be discussed.

U.S. Design Pat. No. D614,021S, issued Apr. 20, 2010 to Lecours, and entitled One-Piece Encircling Anchor, discloses an encircling anchor having a two-piece clip extending outwardly from one face of a two-piece base, and an inwardly compressible insertable shank. The insertable shank is generally diamond shaped with two legs that are mirror images one of the other. Each leg has a catch member to help preclude removal of the encircling anchor from the article it is anchored in. In order to be inserted into or be removed from a receiving aperture in the article, the two legs must deform inwardly. The diamond shape of the inwardly compressible insertable shank actually permits ready compression of the inwardly compressible insertable shank during insertion into a receiving aperture, which is desirable, but also permits ready compression of the inwardly compressible insertable shank during removal from a receiving aperture, which is undesirable.

It is an object of the present invention to provide an anchorable clip for insertion into a receiving aperture in an article and subsequent secure retention by the article.

It is an object of the present invention to provide an anchorable clip for securing to an article.

### SUMMARY OF THE INVENTION

In accordance with one aspect of the present invention there is disclosed a novel anchorable clip for insertion into a receiving aperture in an article and subsequent secure retention by the article. The anchorable clip comprises a first main body portion and a second main body portion together reconfigurable between an initial configuration and an in-use configuration. The first main body portion and the second main body portion together define, in the in-use configuration: an insertable shank; a base; and a clip member. There is at least one displaceable projection projecting outwardly from at least one of the first main body portion and the second main body portion for engaging at least a portion of the article adjacent the receiving aperture to thereby preclude the anchorable clip from being removed from the receiving aperture. The first main body portion comprises a first shank portion of the insertable shank, a first base portion of the base, and a first clip portion of the clip member, and the second main body portion comprises a second shank portion of the insertable shank, a second base portion of the base, and a second clip portion of the clip member.

In accordance with another aspect of the present invention there is disclosed a novel anchorable clip for securing to an article. The anchorable clip comprises: a first main body portion and a second main body portion together reconfigurable between an initial configuration and an in-use configuration. The first main body portion and the second main body portion together define, in the in-use configuration: a base; and a clip member. The first main body portion comprises a first base portion of the base, and a first clip portion of the clip member, and the second main body portion comprises a second base portion of the base, and a second clip portion of the clip member. There is also means for interconnecting the first main body portion and a second main body portion so as to be together reconfigurable between the initial configuration and the in-use configuration.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the anchorable clip according to the present invention, as to its structure, organization, use and method of operation, together with further objectives and advantages thereof, will be better understood from the following drawings in which a presently known embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of a first illustrated embodiment of the anchorable clip according to the present invention, with the anchorable clip in its in-use configuration;

FIG. 2 is a front view of the first illustrated embodiment anchorable clip of FIG. 1, with the anchorable clip in its in-use configuration;

FIG. 3 is a side view of the first illustrated embodiment anchorable clip of FIG. 1, with the anchorable clip in its in-use configuration;

FIG. 4 is a perspective view of the first illustrated embodiment anchorable clip of FIG. 1, but with the anchorable clip in its initial configuration;

FIG. 5 is a front view of the first illustrated embodiment anchorable clip of FIG. 1, with the anchorable clip in its initial configuration;

FIG. 6 is a side view of the first illustrated embodiment anchorable clip of FIG. 1, with the anchorable clip in its initial configuration;

FIG. 7 is a front view of the first illustrated embodiment anchorable clip of FIG. 1, shown moving from its initial configuration to its in-use configuration;

FIG. 8 is a front view of a second illustrated embodiment of the anchorable clip according to the present invention, with the anchorable clip in its in-use configuration;

FIG. 9 is a rear view of the second illustrated embodiment anchorable clip of FIG. 8, with the anchorable clip in its in-use configuration;

FIG. 10 is a top view of the second illustrated embodiment anchorable clip of FIG. 8, with the anchorable clip in its in-use configuration;

FIG. 11 is a bottom view similar of the second illustrated embodiment anchorable clip of FIG. 8, with the anchorable clip in its in-use configuration;

FIG. 12 is a perspective view of the second illustrated embodiment anchorable clip of FIG. 8, with the anchorable clip in its initial configuration;

FIG. 13 is a perspective view of the second illustrated embodiment anchorable clip of FIG. 8, with the anchorable clip in its initial configuration;

FIG. 14 is a side view of the second illustrated embodiment anchorable clip of FIG. 8, with the anchorable clip in its initial configuration;

FIG. 15 is a front view of the second illustrated embodiment anchorable clip of FIG. 8, with the anchorable clip in its initial configuration;

FIG. 16 is a rear view of the second illustrated embodiment anchorable clip of FIG. 8, with the anchorable clip in its initial configuration;

FIG. 17 is a perspective view of the second illustrated embodiment anchorable clip of FIG. 8, shown moving from its initial configuration to its in-use configuration;

FIG. 18 is a perspective view of a third illustrated embodiment of the anchorable clip according to the present invention, with the anchorable clip in its in-use configuration;

FIG. 19 is a front view of the third illustrated embodiment anchorable clip of FIG. 18, with the anchorable clip in its in-use configuration;

FIG. 20 is a side view of the third illustrated embodiment anchorable clip of FIG. 18, with the anchorable clip in its in-use configuration;

FIG. 21 is a top view of the third illustrated embodiment anchorable clip of FIG. 18, with the anchorable clip in its in-use configuration;

FIG. 22 is a bottom view of the third illustrated embodiment anchorable clip of FIG. 18, with the anchorable clip in its in-use configuration;

FIG. 23 is a perspective view of the third illustrated embodiment anchorable clip of FIG. 18, with the anchorable clip in its initial configuration;

FIG. 24 is a front view of the third illustrated embodiment anchorable clip of FIG. 18, with the anchorable clip in its initial configuration;

FIG. 25 is a front view of the second illustrated embodiment anchorable clip of FIG. 18, shown moving from its initial configuration to its in-use configuration; and,

FIG. 26 is a perspective view of a fourth illustrated embodiment of the anchorable clip according to the present invention, with the anchorable clip in its initial configuration.

### DETAILED DESCRIPTION OF THE ILLUSTRATED EMBODIMENTS

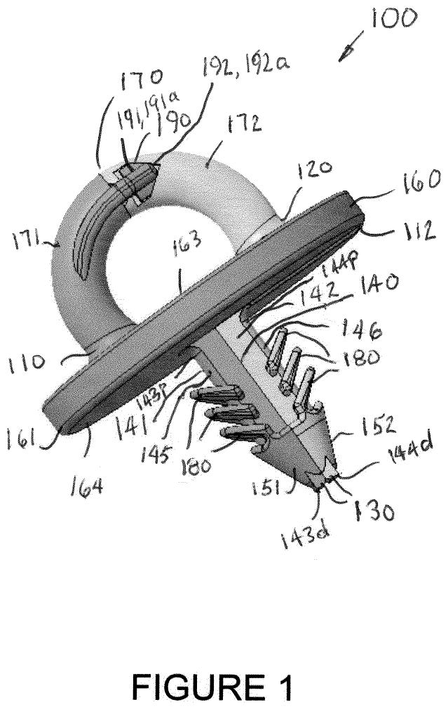

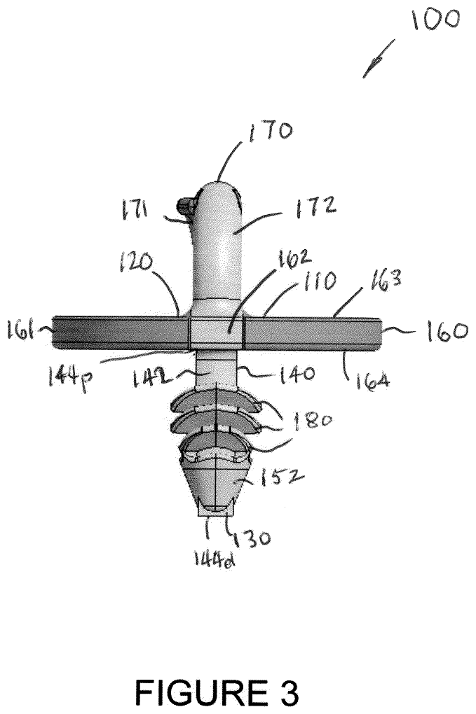

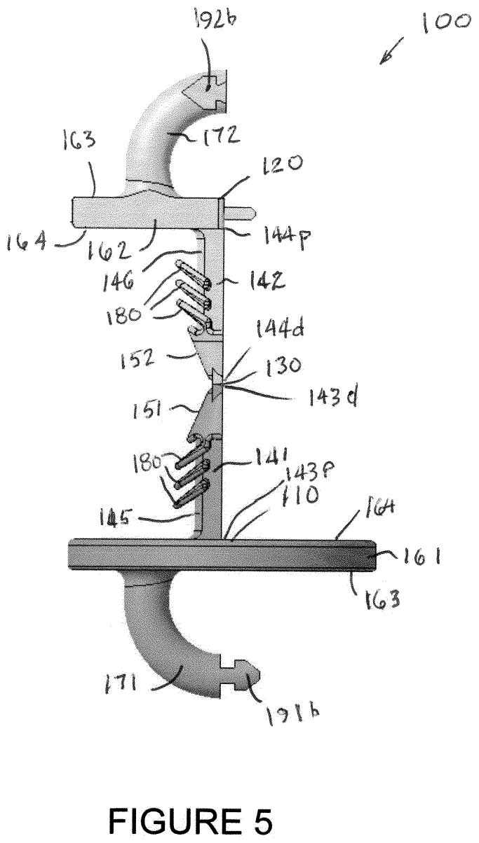

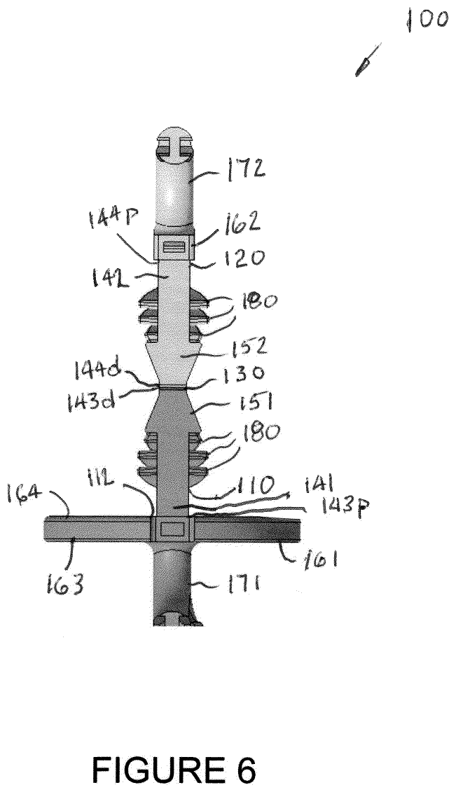

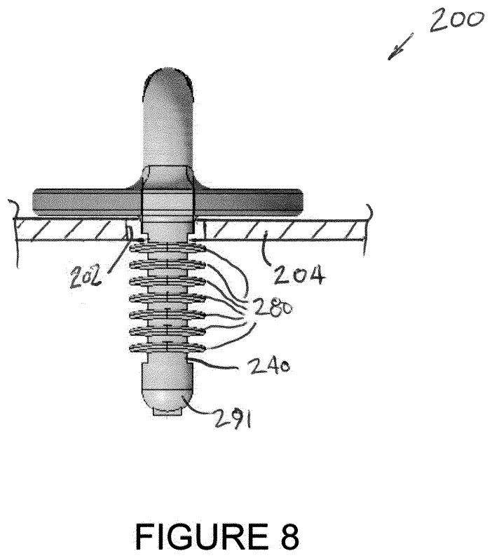

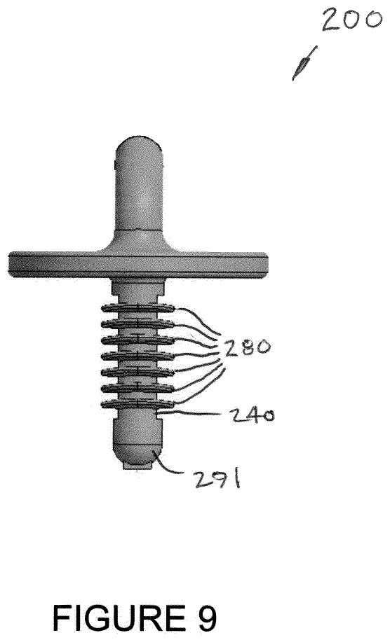

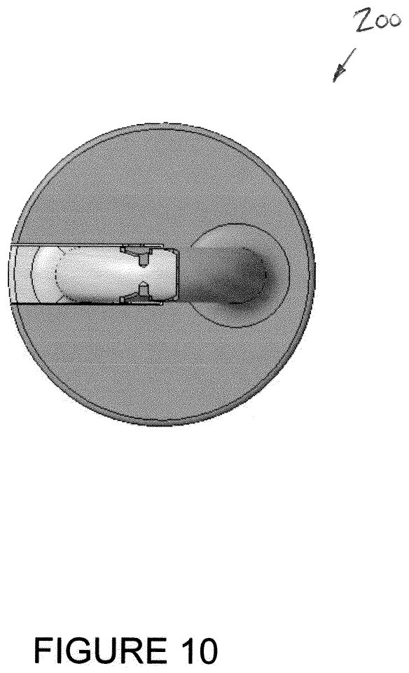

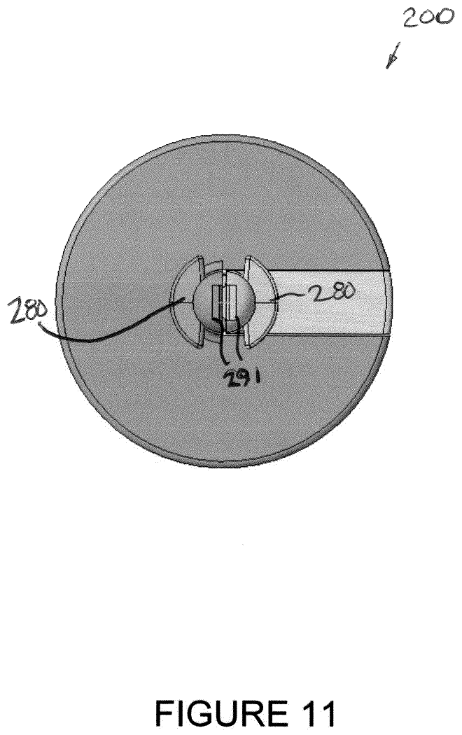

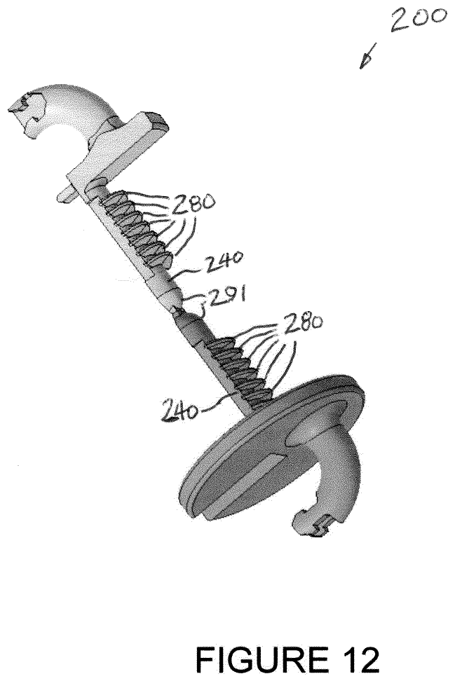

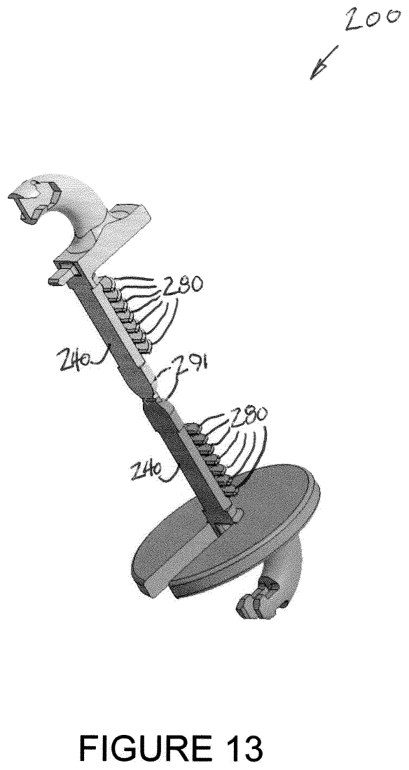

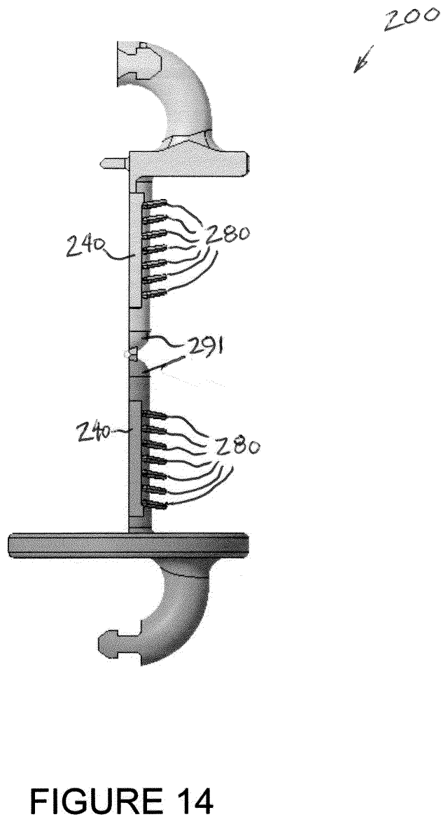

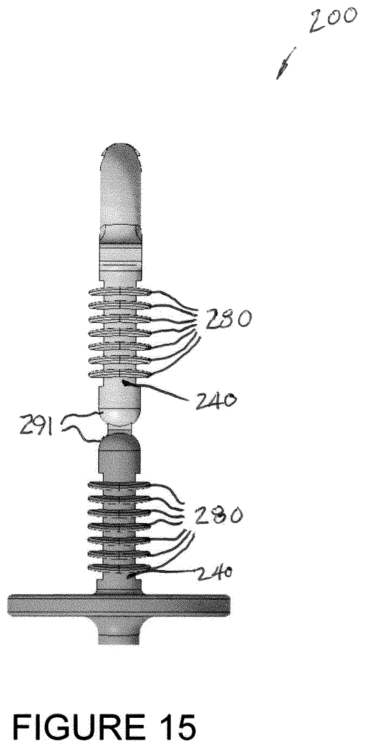

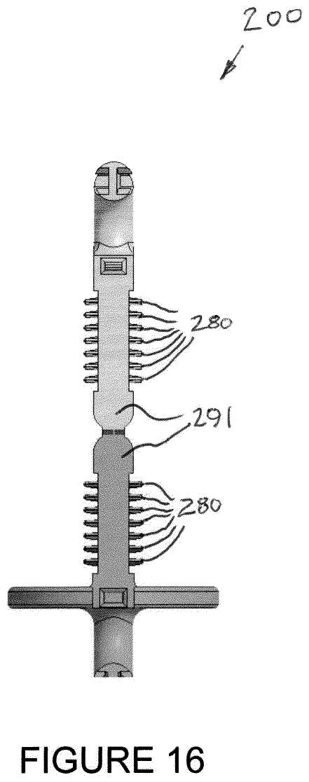

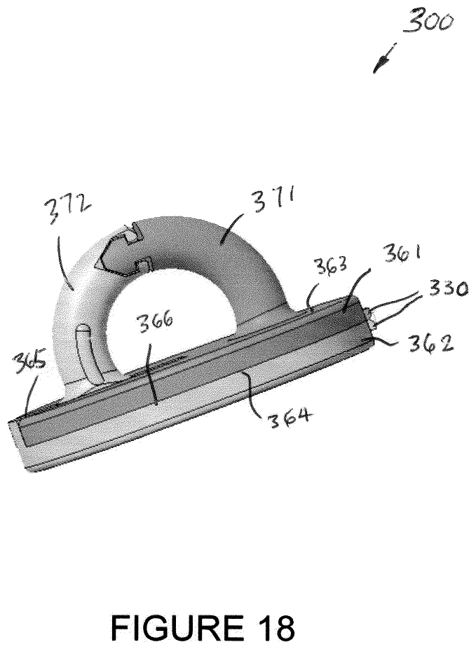

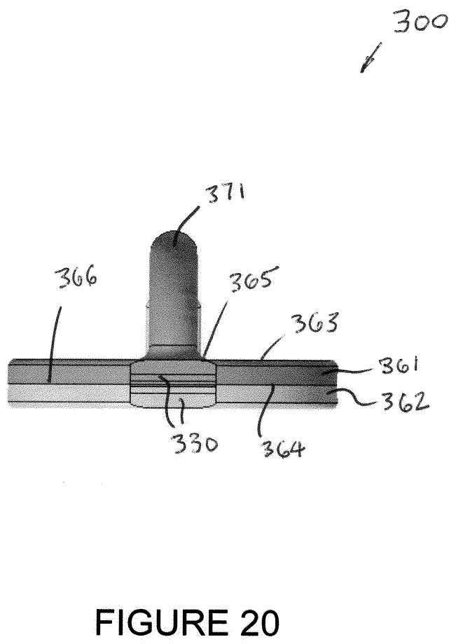

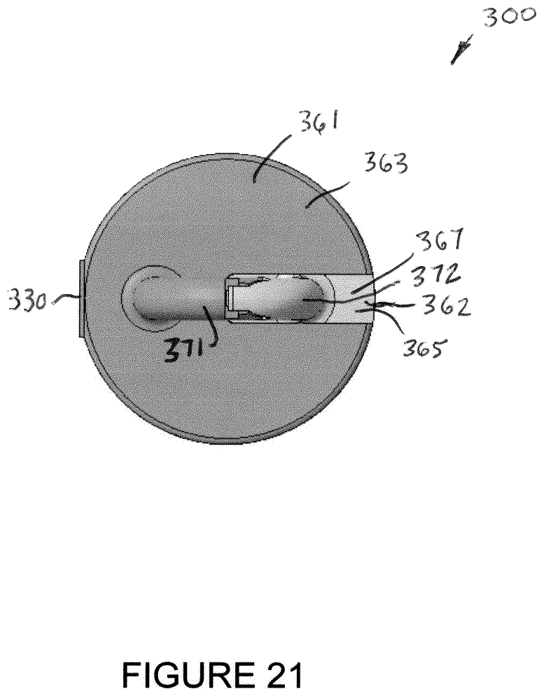

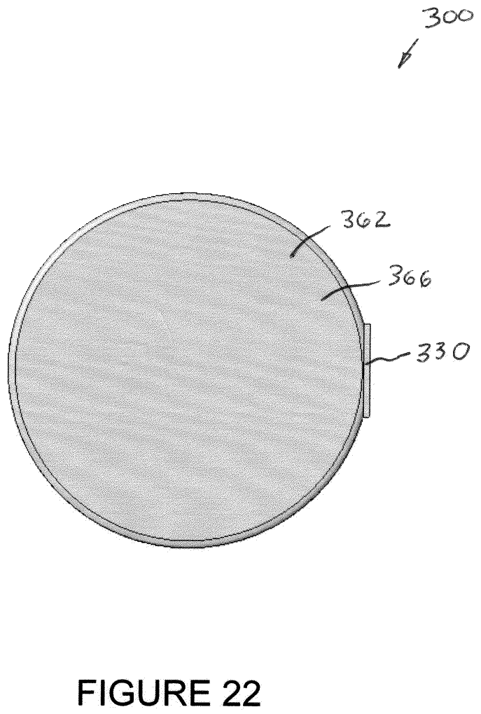

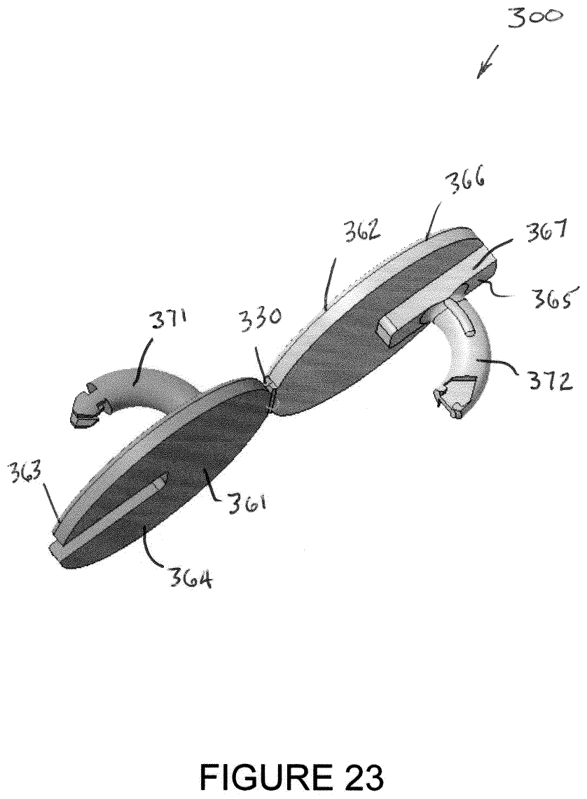

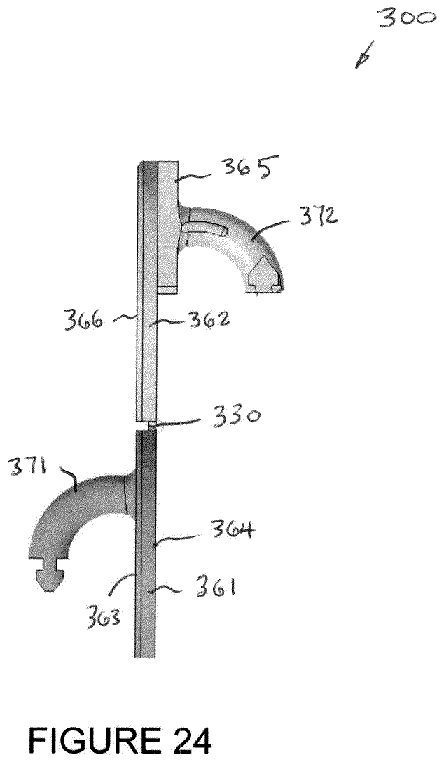

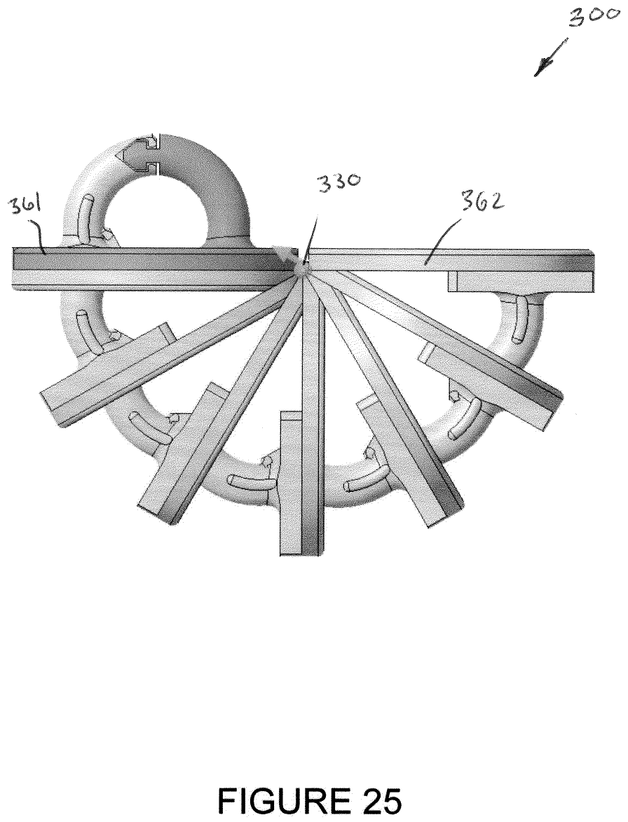

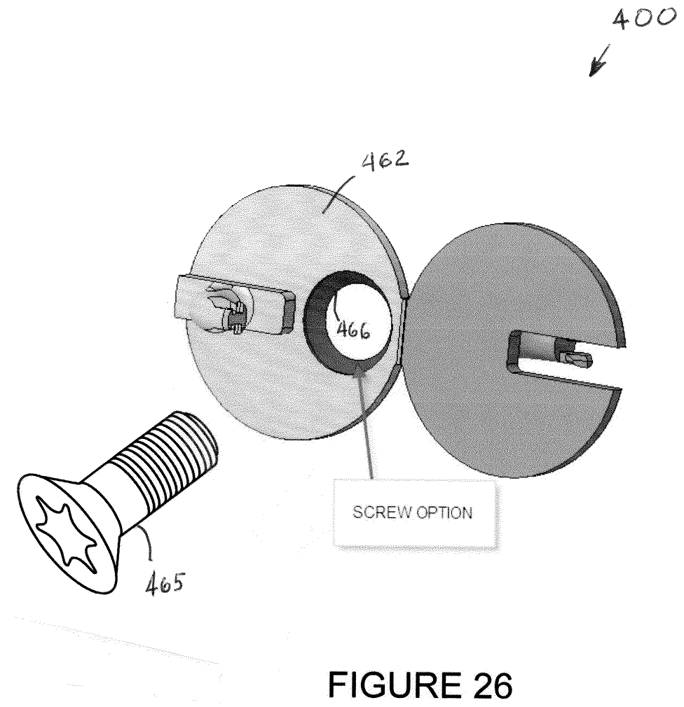

Referring to FIGS. 1 through 26 of the drawings, it will be noted that FIGS. 1 through 7 show a first illustrated embodiment of the anchorable clip 100 according to the present invention, FIGS. 8 through 17 show a second illustrated embodiment of the anchorable clip 200 according to the present invention, FIGS. 18 through 25 show a third illustrated embodiment of the anchorable clip 300 according to the present invention, and FIG. 26 shows a fourth illustrated embodiment of the anchorable clip 400 according to the present invention.

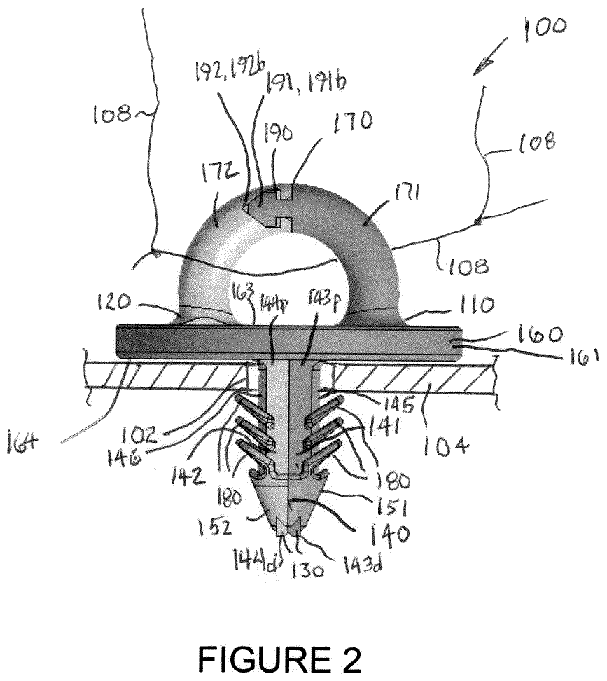

Reference will now be made to FIGS. 1 through 7, which show a first illustrated embodiment of the anchorable clip 100 according to the present invention. As can be readily seen in FIG. 2, the first illustrated embodiment anchorable clip, as indicated by the general reference numeral 100, is for insertion into a receiving aperture 102 in an article 104 and subsequent secure retention by the article 104.

The first illustrated embodiment discloses an anchorable clip, as indicated by the general reference numeral 100, for insertion into a receiving aperture 102 in an article 104, such as a circular drill hole in a hockey net. Once in place, the anchorable clip 100 is subsequently secure retained by way of interference fit with the article 104.

The anchorable clip 100 is for attaching objects 108 such as netting, wires (not specifically shown), and the like, to articles 104, such as a frame, such as a hockey net frame or to an automobile frame (not specifically shown) or a wiring panel (not specifically shown), respectively, among many other types of articles 104.

In brief, the first illustrated embodiment of the anchorable clip 100 comprises a first main body portion 110 and a second main body portion 120, that together define an insertable shank 140, a base 160, and a clip member 170, and also comprises a hinge 130.

More specifically, the first illustrated embodiment of the anchorable clip 100 comprises a first main body portion 110 and a second main body portion 120. As illustrated, but not necessarily, the first main body portion 110 and the second main body portion 120 are integrally formed as one over overall piece and are formed from injection molded from one or more plastic materials.

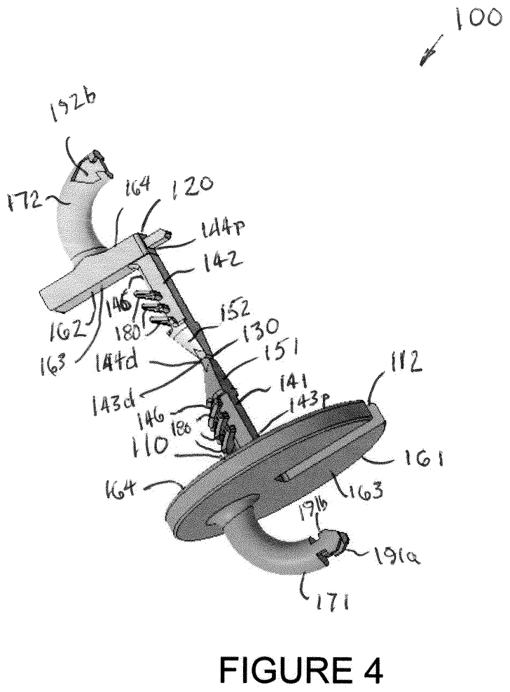

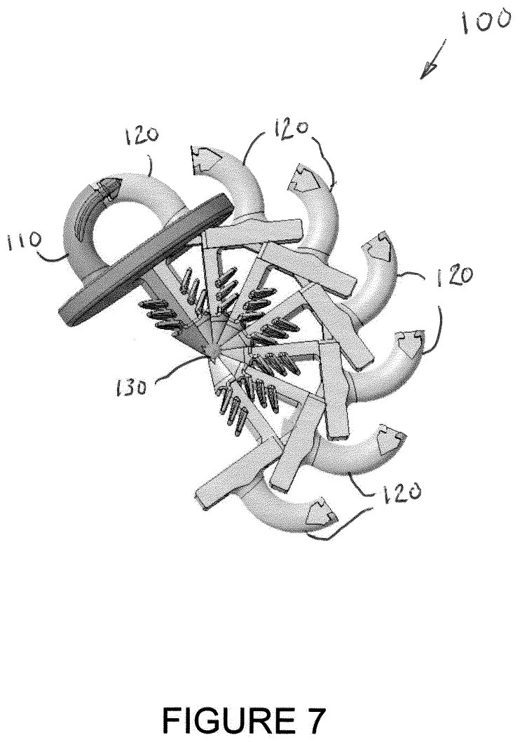

As can be readily seen in the figures, the first main body portion 110 and the second main body portion 120 are together reconfigurable between an initial configuration, as shown in FIGS. 1 through 3, and an in-use configuration, as shown in FIGS. 4 through 6. The first main body portion 110 has a slot 112 therein. The second main body portion 120 is shaped and dimensioned to fit within the slot 112 when the first main body portion 110 and a second main body portion 120 are together reconfigured to the in-use configuration. FIG. 7 shows relative movement of the first main body portion 110 and the second main body portion 120 of the first illustrated embodiment anchoring clip 100 from the initial configuration to the in-use configuration.

In order to have the first main body portion 110 and a second main body portion 120 as one piece, the anchorable clip 100 further comprises means for interconnecting the first main body portion 110 and a second main body portion 120 so as to be together reconfigurable between the initial configuration, as shown in FIGS. 1 through 3, and the in-use configuration, as shown in FIGS. 4 through 6. In the first illustrated embodiment of the anchorable clip 100, the means for interconnecting the first main body portion 110 and a second main body portion 120 so as to be together reconfigurable between the initial configuration and the in-use configuration comprises the hinge 130 interconnecting the first main body portion 110 and a second main body portion 120 for hinged movement between the initial configuration and the in-use configuration. Preferably, but not necessarily, the hinge 130 comprises a living hinge 130 made from one or more plastic materials, as it is preferably integrally formed as one over overall piece with the first main body portion 110 and a second main body portion 120.

In the in-use configuration, the first main body portion 110 and the second main body portion 120 together define the insertable shank 140, the base 160 and the clip member 170.

The main reason that the anchorable clip 100 is movable between the initial configuration, as shown in FIGS. 1 through 3, and an in-use configuration, as shown in FIGS. 4 through 6, is to allow the placement of objects 108 such as netting and wires within the opening defined by the first main body portion 110 and the second main body portion 120.

As can be readily seen in FIGS. 4 through 6, the first main body portion 110 comprises a first shank portion 141 of the insertable shank 140, a first base portion 161 of the base 160, and a first clip portion 171 of the clip member 170, and the second main body portion 120 comprises a second shank portion 142 of the insertable shank 140, a second base portion 162 of the base 160, and a second clip portion 172 of the clip member 170. When the first main body portion 110 and the second main body portion 120 are brought together to form the in-use configuration, the first shank portion 141 and the second shank portion 142 form the insertable shank 140. Similarly, the first base portion 161 and the second base portion 162 together form the base 160. Also, the first clip portion 171 and the second clip portion 172 form the clip member 170.

The first shank portion 141 of the insertable shank 140 has a proximal end 143p at the base 160 and a distal end 143d remote from the base 160, and the second shank portion 142 of the insertable shank 140 has a proximal end 144p at the base 160 and a distal end 144d remote from the base 160. The first shank portion 141 also comprises a reinforcing rib 145 along its length and the second shank portion 142 comprises a reinforcing rib 146 along its length.

Also, the hinge 130 is attached to the first shank portion 141 of the insertable shank 140 adjacent, and preferably at, the distal end 144 thereof and wherein the hinge 130 is attached to the second shank portion 142 of the insertable shank 140 adjacent, and preferably at, the distal end 144 thereof.

The insertable shank 140 is insertable into an aperture in an article 104, such as a circular drill hole in a hockey net, as will be discussed in greater detail subsequently. Preferably, the insertable shank 140 comprises solid non-hollow insertable shank 140 for the purposes of strength and robustness. Also preferably, it is contemplated that the solid insertable shank 140 is substantially incompressible in a lateral direction to the shank, in order to make the insertable shank 140 more difficult to remove from the receiving aperture 102.

It is also contemplated that the shank could be partially hollow for the sake of material reduction, among other reasons.

The base 160 has an exposed face 163 and a hidden face 164 that face in opposite directions one to the other. In the first illustrated embodiment, the base 160 is thin between the exposed face 163 and the hidden face 164, the exposed face 163 and a hidden face 164 are substantially parallel one to the other, and the base 160 is basically disc shaped. The insertable shank 140 extends outwardly from the hidden face 164 of the base 160 and is preferably perpendicularly oriented to the hidden face 164 of the base 160. Similarly, the clip member 170 extends outwardly from the exposed face 163 of the base 160 in an opposite direction to the insertable shank 140, and is preferably perpendicularly oriented to the exposed face 163 of the base 160.

The anchorable clip 100 comprises, as aforesaid, the first clip portion 171 and the second clip portion 172. The first clip portion 171 and the second clip portion 172 are each substantially quarter-circular in shape to together form the semi-circular clip member 170. Any other suitable shape of clip member 170 may also be used. The semi-circular clip member 170 defines an opening in which objects 108 such as netting, wires (not specifically shown), and the like, can be received and retained. In this manner, the objects 108 are retained on or at an article 104, such as a frame, such as a hockey net frame or to an automobile frame (not specifically shown) or a wiring panel (not specifically shown), respectively, among many other types of articles 104.

In order to permit the anchorable clip 100 to be retained in the article 104, there is at least one displaceable projection 180. Each of the at least one displaceable projections 180 projects outwardly from at least one of the first main body portion 110 and the second main body portion 120 for engaging at least a portion of the article 104 adjacent the receiving aperture 102 to thereby preclude the anchorable clip 100 from being removed from the receiving aperture 102.

In the first illustrated embodiment, the at least one displaceable projection 180 comprises a plurality of displaceable projections 180, and even more specifically comprises three pairs of displaceable projections 180, with the three pairs of displaceable projections 180 projecting outwardly from the insertable shank 140 towards the base 160 member. More particularly, three of the displaceable projections 180 project outwardly from the first shank portion 141 of the insertable shank 140 towards the base 160 member, and three of the displaceable projections 180 project outwardly from the second shank portion 142 of the insertable shank 140 towards the base 160 member. The plurality of displaceable projections 180 project outwardly from the first shank portion 141 are substantially parallel one to the others and the plurality of displaceable projections 180 project outwardly from the second shank portion 142 are substantially parallel one to the others.

As can be readily seen, the displaceable projections 180 are shaped and dimensioned to preclude the anchorable clip 100 from readily being removed from the article 104. Often, but not necessarily, there is a threshold force above which the anchorable clip 100 can readily be removed from the article 104 without fracturing the displaceable projections 180.

Preferably, each displaceable projection 180 comprises a flexible projection 180 in order to have the displaceable projections 180 permit insertion of the insertable shank 140 into the aperture, yet also be in place to preclude subsequent removal of the insertable shank 140 from the aperture. As can be readily seen, each flexible projection 180 comprises a flexible fin.

The anchorable clip 100 further comprises a first head portion 151 disposed on the first shank portion 141 and a second head portion 152 disposed on the second shank portion 142. The first head portion 151 narrows towards the distal end 144 of the first shank portion 141 and the second head portion 152 narrows towards the distal end 144 of the second shank portion 142. The first head portion 151 comprises a first stop surface 153 facing the proximal end 143p of the first shank portion 141 and the second head portion 152 comprises a second stop surface 154 facing the proximal end 144p of the second shank portion 142. Further, the first head portion 151 comprises a reinforcing rib 155 along its length and the second head portion 152 comprises a reinforcing rib 156 along its length.

In order to keep the anchorable clip 100 in the in-use configuration, the anchorable clip 100 further comprises a locking mechanism 190 to retain the first main body portion 110 and a second main body portion 120 together in their in-use configuration. In the first illustrated embodiment, the locking mechanism 190 comprises at least one head portion 191 disposed on the first clip portion 171 and a co-operating at least one socket 192 disposed on the second clip portion 172. Even more preferably, the at least one head portion comprises a first head portion 191a and a second head portion 191b each disposed on the first clip portion 171 and the co-operating at least one socket comprises a first socket portion 192a and a second socket portion 192b each disposed on the second clip portion 172.

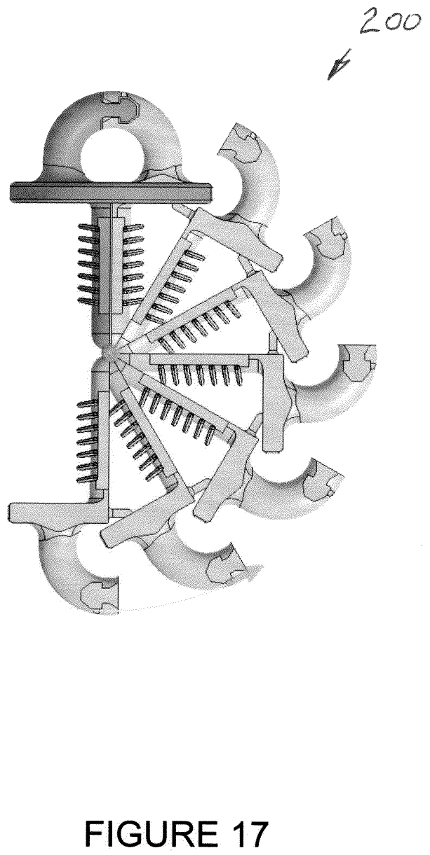

Reference will now be made to FIGS. 8 through 17, which show a second illustrated embodiment of the anchorable clip 200 according to the present invention. As can be readily seen in FIG. 17, the second illustrated embodiment anchorable clip, as indicated by the general reference numeral 200, is for insertion into a receiving aperture 202 in an article 204 and subsequent secure retention by the article 204. The second illustrated embodiment clip 200 is similar to the first illustrated embodiment anchorable clip 100 except that the insertable shank 240 is longer, the flexible projections 280 are semi-circular in shape and there are seven pairs of the flexible projections 280. Also, the at least one head portion 291 is shaped slightly differently.

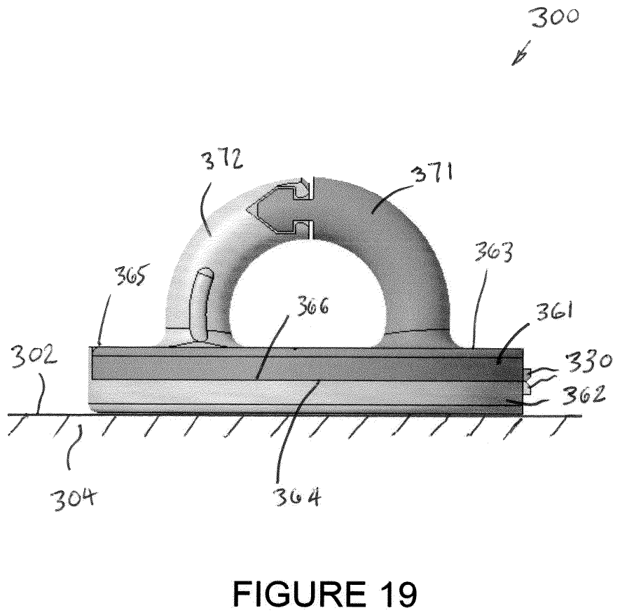

Reference will now be made to FIGS. 18 through 25, which show a third illustrated embodiment of the anchorable clip 300 according to the present invention. As can be readily seen in FIG. 19, the third illustrated embodiment clip, as indicated by the general reference numeral 300, is for securing to a receiving surface 302 on an article 304 and subsequent secure retention by the article 304. The third illustrated embodiment anchorable clip 300 is similar to the first illustrated embodiment anchorable clip 100 and the second illustrated embodiment anchorable clip 100 except that the insertable shank 140,240 is not present. Further, the first base portion 161,261 and the second base portion 162,262 are each a different shape. Further, the living hinge 330 is attached to the first base portion 361 and is attached to the second base portion 362. More specifically, the living hinge 330 is attached to the first base portion 361 adjacent the perimeter edge thereof and is attached to the second base portion 362 adjacent the perimeter edge thereof. The first base portion 361 has a clip-presenting face 363 and a substantially flat face 364 and the second base portion 362 has a clip-presenting face 365 and a substantially flat face 366. There is also a rectangular protrusion 367 on the clip-presenting face 363 of the second base portion 362. The first clip portion 371 projects upwardly from the clip-presenting face 363 of the first base portion 361 and the second clip portion 372 projects upwardly from the rectangular protrusion 367 on the clip-presenting face 365 of the second base portion 362. Further, the first base portion 361 is thin between the clip-presenting face 363 and a substantially flat face 364 and the second base portion 362 is thin between the clip-presenting face 365 and the substantially flat face 366. In the in-use configuration, the substantially flat face 364 of the first base portion 361 and the clip-presenting face 365 of the second base portion 362 beyond the rectangular protrusion 367 are in contact one with the other. A suitable adhesive 368 on the substantially flat face 366 of the second base portion 362 is used to adhere the anchorable clip to a receiving surface 302 on an article 304.

Reference will now be made to FIG. 26, which show a fourth illustrated embodiment of the anchorable clip 400 according to the present invention. As can be readily seen in FIG. 26, the fourth illustrated embodiment anchorable clip, as indicated by the general reference numeral 400, is for securing to a receiving surface (not specifically shown) in an article (not specifically shown) and subsequent secure retention by the article. The fourth illustrated embodiment clip 400 is similar to the third illustrated embodiment anchorable clip 300 except that the suitable adhesive 366 is not used. Instead a threaded fastener 465 extends through an aperture 466 in the second base portion 462 to secure the anchorable clip 400 to a receiving surface on an article.

As can be understood from the above description and from the accompanying drawings, the present invention provides an anchorable clip for insertion into a receiving aperture in an article and subsequent secure retention by the article, and an anchorable clip for securing to an article, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the combination infant mat and carrying bag, of the present invention, without departing from the spirit and scope of the accompanying claims.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”, “for example”) provided herein, is intended merely to better illuminate embodiments of the invention and does not pose a limitation on the scope of the invention unless otherwise claimed. No language in the specification should be construed as indicating any non-claimed element as essential to the practice of the invention.

Illustrated embodiments of this invention are described herein. Variations of those illustrated embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An anchorable clip for insertion into a receiving aperture in an article and subsequent secure retention by the article, the anchorable clip comprising:
a first main body portion and a second main body portion together reconfigurable between an initial configuration and an in-use configuration;
wherein the first main body portion and the second main body portion together define, in the in-use configuration:
an insertable shank;
a base; and,
a clip member;
at least one displaceable projection projecting outwardly from at least one of the first main body portion and the second main body portion for engaging at least a portion of the article adjacent the receiving aperture to thereby preclude the anchorable clip from being removed from the receiving aperture; and,
wherein the first main body portion comprises a first shank portion of the insertable shank, a first base portion of the base, and a first clip portion of the clip member, and the second main body portion comprises a second shank portion of the insertable shank, a second base portion of the base, and a second clip portion of the clip member.

2. The anchorable clip according to claim 1, wherein the at least one displaceable projection comprises a plurality of displaceable projections.

3. The anchorable clip according to claim 1, wherein each displaceable projection comprises a flexible projection.

4. The anchorable clip according to claim 3, wherein each flexible projection comprises a flexible fin.

5. The anchorable clip according to claim 3, wherein the insertable shank comprises solid insertable shank.

6. The anchorable clip according to claim 5, wherein the insertable shank comprises non-hollow insertable shank.

7. The anchorable clip according to claim 6, wherein the solid insertable shank is substantially incompressible in a lateral direction.

8. The anchorable clip according to claim 1, further comprising means for interconnecting the first main body portion and a second main body portion so as to be together reconfigurable between the initial configuration and the in-use configuration.

9. The anchorable clip according to claim 8, wherein the means for interconnecting the first main body portion and a second main body portion so as to be together reconfigurable between the initial configuration and the in-use configuration comprises a hinge interconnecting the first main body portion and a second main body portion for hinged movement between the initial configuration and the in-use configuration.

10. The anchorable clip according to claim 9, wherein the hinge interconnecting the first main body portion and a second main body portion for hinged movement between the initial configuration and the in-use configuration comprises a living hinge.

11. The anchorable clip according to claim 10, wherein the living hinge is made from one or more plastic materials.

12. The anchorable clip according to claim 1, wherein the first shank portion of the insertable shank has a proximal end at the base and a distal end remote from the base, and the second shank portion of the insertable shank has a proximal end at the base and a distal end remote from the base.

13. The anchorable clip according to claim 13, wherein the hinge is attached to the first shank portion of the insertable shank adjacent the distal end thereof and wherein the hinge is attached to the second shank portion of the insertable shank adjacent the distal end thereof.

14. The anchorable clip according to claim 13, wherein the hinge is attached to the first shank portion of the insertable shank at the distal end thereof and wherein the hinge is attached to the second shank portion of the insertable shank at the distal end thereof.

15. The anchorable clip according to claim 1, wherein the at least one displaceable projection comprises a plurality of displaceable projections.

16. The anchorable clip according to claim 15, wherein the plurality of displaceable projections project outwardly from both the first shank portion and the second shank portion.

17. The anchorable clip according to claim 16, wherein the plurality of displaceable projections project outwardly from both the first shank portion and the second shank portion towards the base member.

18. The anchorable clip according to claim 17, wherein the plurality of displaceable projections project outwardly from the first shank portion are substantially parallel one to the others and the plurality of displaceable projections project outwardly from the second shank portion are substantially parallel one to the others.

19. The anchorable clip according to claim 18, further comprising a first head portion disposed on the first shank portion and a second head portion disposed on the second shank portion.

20. An anchorable clip for securing to an article, the anchorable clip comprising:
a first main body portion and a second main body portion together reconfigurable between an initial configuration and an in-use configuration;
wherein the first main body portion and the second main body portion together define, in the in-use configuration:
a base; and,
a clip member;
wherein the first main body portion comprises a first base portion of the base, and a first clip portion of the clip member, and the second main body portion comprises a second base portion of the base, and a second clip portion of the clip member; and,
means for interconnecting the first main body portion and a second main body portion so as to be together reconfigurable between the initial configuration and the in-use configuration.
